(19) United States
(12) Patent Application Publication
(10) Pub. No.: US 2007/0295196 A1
(43) Pub. Date: Dec. 27, 2007

(54) Acoustic Guitar Control Unit

(76) Inventor: Heikki Raisanen, Muurame (FI)

Correspondence Address: KATTEN MUCHIN ROSENMAN LLP, 575 MADISON AVENUE, NEW YORK, NY, 10022-2585, US

(21) Appl. No.: 10/590,182

(22) PCT Filed: Feb. 23, 2005
(86) PCT No.: PCT/FI05/00111

§ 371 Date: Aug. 18, 2006

(30) Foreign Application Priority Data
Feb. 23, 2004 (FI) 20040277

(51) Int. Cl. G10H 1/02

(52) U.S. Cl. 84/737

(57) ABSTRACT

An electromechanical control unit (12) for a musical instrument having keypad and/or touch pad areas (102) for controlling a signal processing unit, wherein the control unit (12) includes a surface element (101), whereby settings and values of said signal processing unit that can be changed by the user are controlled by touching of the surface element, which surface element has keypad and/or touch areas (102) provided with fixed and/or alternating symbols whereby changeable parameter values of the signal processing unit are controlled by touching and/or by gliding on said symbol with finger(s) or some other means, and wherein in order to adjust the parameter values that can be changed by the user the control unit consists of a thin and elastic layered structure whereby touching it generates there between the electrode surfaces a charge or voltage or capacitance change the place and/or amplitude of which is calculated with a microprocessor or alike, and based on this information said changeable parameter values are changed.

The invention relates to musical instruments control units. Especially it is suitable for use in acoustic guitars.

### BACKGROUND OF INVENTION

Acoustic guitars have been provided with pickups and their preamplifiers for many tens years. The preamplifiers typically have a control unit which for example may consist of volume, bas, middle range and treble controllers. The controllers are typically slide or rotary potentiometers and various kind of switches. In some preamplifiers displays, such as LCD displays, may be used to show various parameters.

Installing current preamplifiers require typically a quite large hole that has to be routed into the side of the guitar, into which the control unit is installed. Because acoustic guitars are often very valuable and sensitive for changes, large holes make them less valuable and their sound characteristics may become worse.

During the past years there has been different ways in order to offer suitable controls to adjust the preamplifier parameters with as few holes as possible, or none extra holes. Companies like L.R. Baggs and Shadow have for example manufactured different control units that can be installed into the guitar sound hole. Their problem is that the controllers become very small, slide controls are difficult to use, or at least enough of them to include for all necessary today's adjustments, because the place has is very limited size. In electric guitars there has been ideas to integrate controllers to pick guard, for example at U.S. Patent Application Nr 20040003703 describes a pick guard with built in controllers.

U.S. Pat. No. 5,917,437 discloses a keyboard structure which is resistant for hard impacts wherein under a solid and hard surface there is a transducer element with a patterning corresponding a keyboard and silk-screen printed with silver paste. In the structure presented in the invention it is presented that a so-called electret bubble film would be used, as has been described in U.S. Pat. No. 4,654,546. It shows how a constant electric charge can be injected into a dielectric electret bubble film, such as polypropen, including flat and/or torn gas blisters.

The above mentioned keyboard inventions have many disadvantages when the object is a versatile device, thin construction and a preferable mass production. They neither present solutions for a such thin and economical transducer structure as possible nor solutions with as economical and small current consumption electronics as possible. They also do not present solutions how to realize a glide controller.

Prior art discloses also a method presented in WO publication 9606718 for swelling a foamed plastic film wherein the amount of gas it contains can be even doubled. EP Patent publication EP-B1-0775049 discloses how a thin film including flat gas bubbles and oriented biaxially is charged electrically so that partial discharges occur inside it.

Prior art discloses also keyboards that are based on the change in capacitance when touched. There is also new ways to make piezoelectric keypads with printable paste or paint which includes piezoelectric crystals, such as from company Algra Ltd in Switzerland.

### SUMMARY OF THE INVENTION

The object of the present invention is the removal of the disadvantages of the prior art and to solve them with a thin and elastic control unit of a new type that has no mechanical electrical components, and for the installation of which not necessarily a single hole or at least its size in minimized, needs to be bored or routed into the musical instrument itself. The second object of the present invention is a thin and elastic digital electronic control unit of a new type. The third object of the present invention is an acoustic guitar control unit with a control unit and a display or LEDs mounted on each other in order to provide visual information of the adjustment of the controllers. The fourth object of the present invention is digital electronics of new type wherein all the adjustments are made digitally with one or several touch-sensitive slide controllers. The fifth object of the present invention is to minimize the number of preamplifiers the control unit needs and to optimize the need of processor calculations, and economical manufacturing costs. The control unit according to the invention is especially suitable for use in acoustic guitars.

With one embodiment of the invention the operation of the keyboard can be affected with the strength that it has been pressed.

In one embodiment of the invention the control unit has a structure wherein a signal electrode pattern has been arranged on one surface of the transducer film with preferably one row having sequentially several signal electrode areas coupled together with resistors or capacitors. Thus the number of preamplifiers needed can be minimized and a smaller current consumption is achieved.

In a preferred embodiment of the invention, the transducer is film which is an electret bubble film wherein the amount of gas that the gas bubbles contain before it is charged with a strong electric field has been increased to over 50% of its volume, for example by swelling it. The transducer can also be piezoelectric material such as pvdf or printed piezoelectric paint.

In the structure according to the invention the object is a very thin structure, however such a construction that provides a very clear analog voltage information about the place that has been pressed and the strength of pressing. When the whole element is thin and only a thin protective film is arranged on it, even light pressing is enough to produce a good signal-to-noise ratio. The control unit according to the invention becomes very flexible and can follow the round sides of acoustic guitar.

In the control unit according to the invention the microcontroller and/or signal processor unit in the electronics part has a suitable algorithm with which the amplification of the control unit's own preamplifiers can be increased or adjust the touch sensitivity appropriate for the user by the user from the interface of the device or automatically.

The control unit according to the invention is very wear-resistant and it has no separate moving parts, but its outer surface is a smooth plastic film or even thin metal film. It is easy to keep clean and it even tolerates splash water. The outer film can have a pattern including visual information and it can be easily changed to another, for example to one with different colour.

In a preferred embodiment of the invention the signal and ground electrode layers and the number of transducer films is arranged so that the number of electronic components needed is considerably less and on the other hand a maximal operational accuracy is achieved and easily processable signal information is produced without need for complex algorithms that require great amount of calculating capacity.

Characteristic for one preferred embodiment and method of the invention is that the electrode materials have been printed directly onto the surface of the transducer film, onto its both sides, without heat with only silver paste that is dried with UV light, and the resistors arranged between them are arranged directly onto the surface of the transducer film. Thus the structure of the present invention becomes very thin and elastic.

When the manufacturing method of the invention is used the need of the transducer element material can be optimized and the loss can be minimized. Additionally the transducer according to the invention is less sensitive for different disturbances and breaking.

With the method according to the invention film-like control unit with different size and form that are very well protected against electrostatic discharges and electromagnetic noise, and which from their outer surface are of smooth plastic film, can be manufactured from the element material very fast and economically.

The control unit according to the invention can also be arranged under the display because it is very sensitive for pressing.

The characteristic features of the control unit and method for its manufacture are in detail presented in the enclosed independent claims.

### SHORT DESCRIPTION OF THE DRAWINGS

In the following the invention is described in detail buy way of an example by referring to the enclosed drawings wherein

FIG. 1 presents an acoustic guitar wherein a control unit according to the invention is arranged in the top of the guitar adjacent to the neck,

FIG. 2 presents the top view of the control unit according to the invention,

FIG. 3a presents a cross section of the control unit according to the invention,

FIG. 3b presents a top view of one of the most relevant layers of the control unit according to the invention,

FIG. 3c presents the layer according to FIG. 3b from underside.

### DESCRIPTION OF THE PREFERRED EMBODIMENTS

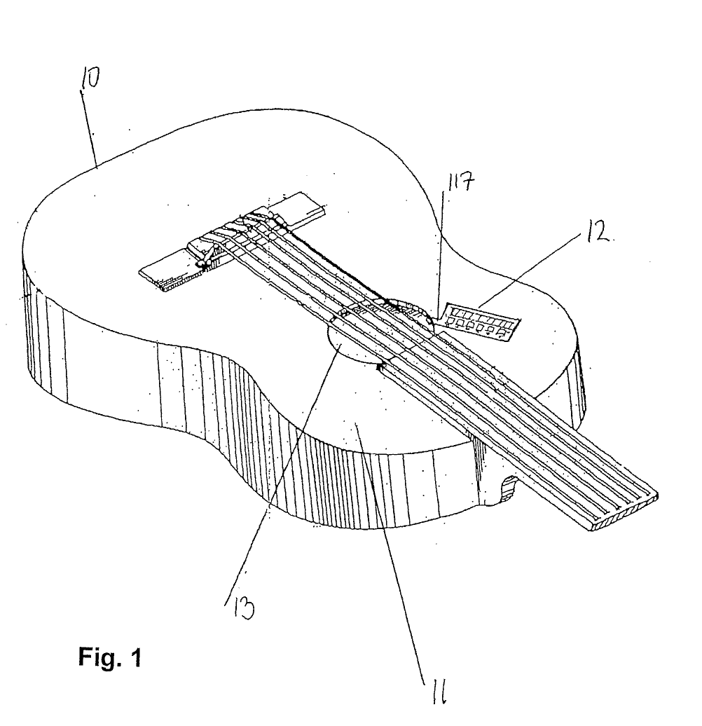

FIG. 1 discloses an acoustic guitar 10, wherein into the top 11 adjacent to the neck is installed a control unit 12 according to the invention. At the top of the guitar there is a sound opening 13, wherefrom a band-like so called cable region 117 from the control unit continues into inside of the guitar and the electronic unit being installed therein.

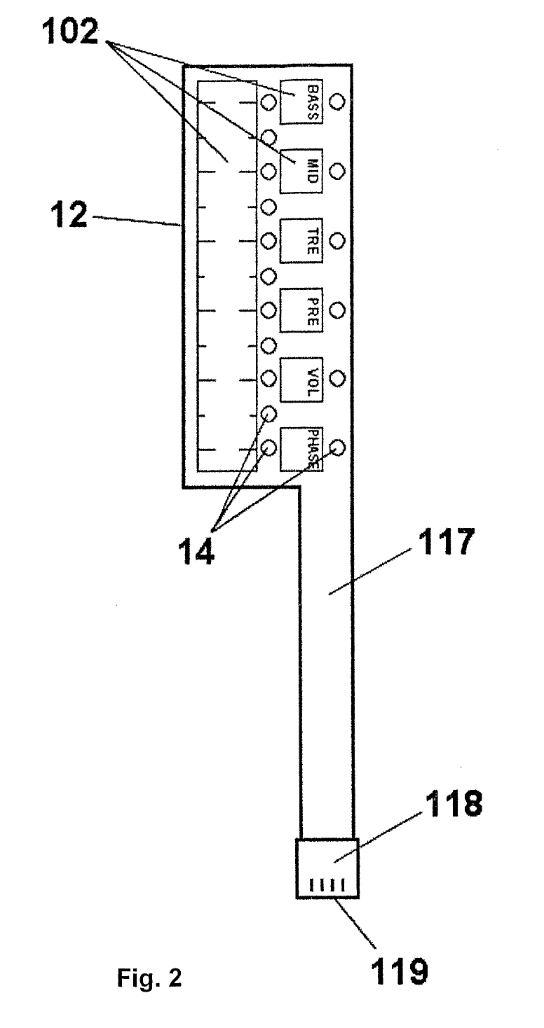

In the view depicted in FIG. 2 there is a control unit according to the invention seen as a top view. With help of LEDs 14 the user is given visual response information and information of the operations and their adjustments. The printed symbols 102 tell where to press in order to adjust a certain operation.

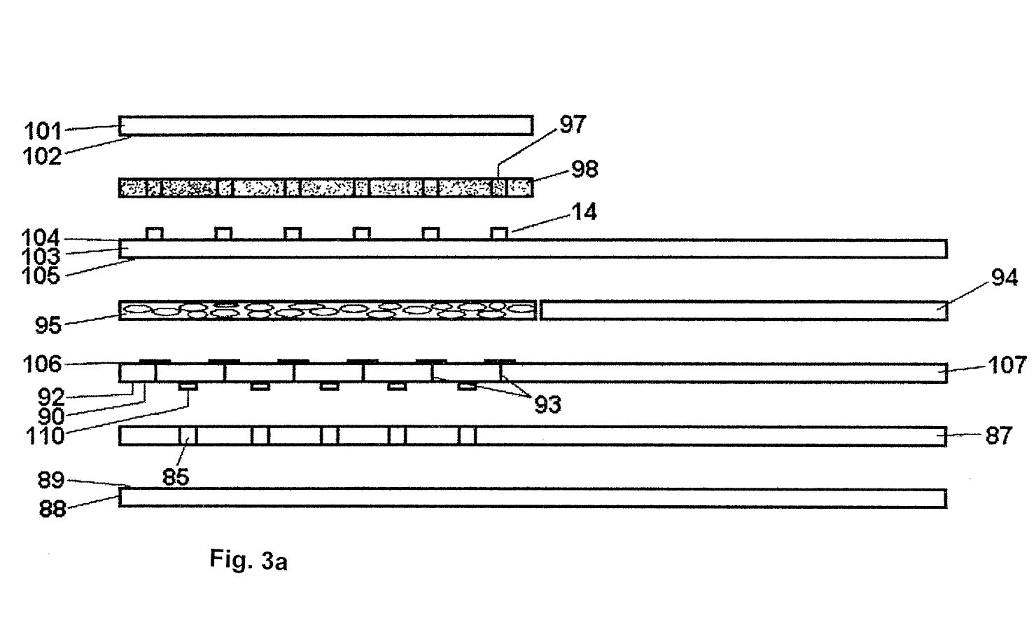

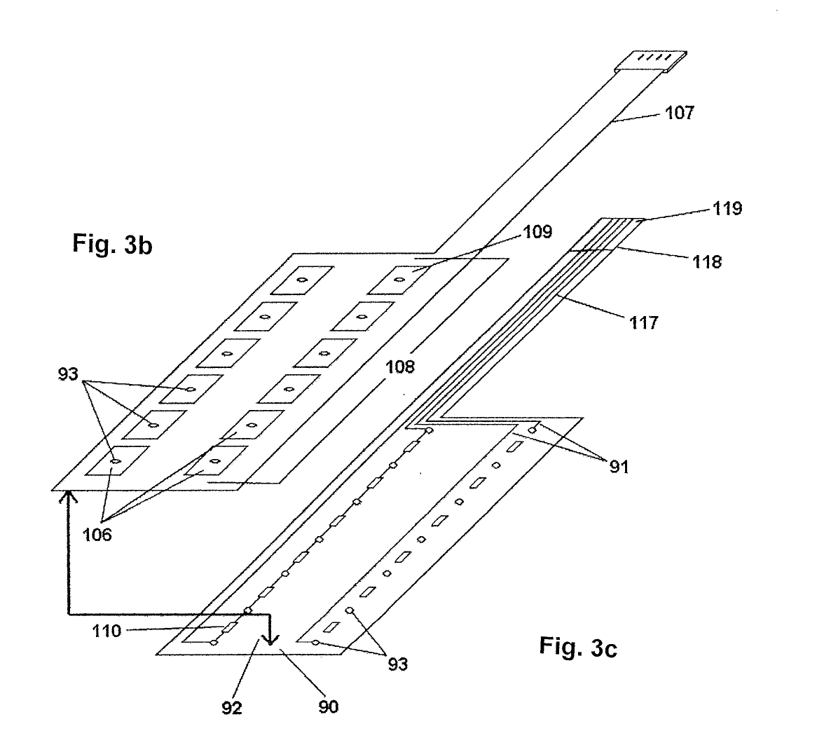

In a cross section view in FIG. 3a can be seen different layers of a touch-sensitive control unit the total thickness of them being in the range of 2 mm. The outer surface layer 101 is preferably a smooth, wear-resistant unitary surface, for example polyester of thickness in the range of 0.1 mm. The surface layer 101 can also be silicon a moulded or injection-moulded plastic, hard or elastic soft element with bosses or grooves arranged into it in order to give a better touch to the user of the place he is pressing.

Symbol patterns 102 of the touch pad have been arranged on the under side of the film 101 by silk-printing. Subsequently the element has a layer 103 of thin plastic film, for example polyimide or polyester, on the upper surface 104 of which has been arranged conductors of LEDs 14, by etching or by silk-printing. Because the LEDs 14 are at their thinnest in the order of 0.2 mm, it is reasonable to arrange a film 98 between the layers 101 and 103 of some material that is suitably thick and elastic; it may even be soft like cellular plastic, into which holes 97 have been cut in the places for LEDs 14. On the under side of the film 103 is arranged a ground electrode pattern 105 that covers the whole area. When going even deeper the next layer is an electromechanical layer 95 which preferably is Emfit® film the use and properties of which has been in detail described for example in publications U.S. Pat. No. 6,078,006 ja U.S. Pat. No. 6,242,683. Adjacent to the film 95 there is an isolation 94 which principally can also be arranged by silk-printing. Instead of Emfit® film also some other elastic, uncharged material can be used, and thus only the capacitance change can be utilized in the calculations described later on. Such a material is however not so exact and the structure does not become so thin. Next in the structure there is the signal electrode pattern 106 of the Emfit film arranged on the upper surface of a plastic film 107, which also can be a printed circuit card. In detail this layer is described in FIG. 3b. It has to be noted that the signal electrode pattern can have the desired form and the different areas can be rectangular, oval or round. The signal electrode pattern consists of areas 106 when pressed the element identifies the pressing by generating a charge impulse. The exceptional in the invention is that into the element has been formed a row 108 consisting of several subsequent areas 106, wherein the areas 106 are somewhat narrower than the finger width, and which areas are very near each other, preferably in the range of 0.5 mm. The purpose of this row 108 is to form a sensor matrix that senses the place in the row that has been pressed as well as moving the finger along the row. The purpose of this is to adjust a desired operation at a certain moment, for example the bass frequencies or volume, louder or less. Between every area of the row 108 a resistor is arranged by silk-printing or by using a little chip-resistor 110, and only the outer areas 109 of the row have been connected to the preamplifiers and further to the microcontrollers.

When necessary the layer 107 can either be of this plastic layer, like polyester or polyimide, or of thin circuit board material. However a hole 93 has been arranged in the place of each area 106, from which each area is coupled electrically to the lower surface 92. On the lower surface 92 there is arranged by silk-printing a transparent isolation layer 90 on the conductors. The ground plane 89 is necessary for noise protection. It can be printed on the isolation 90, or it can be arranged on the surface of its own plastic film 88. If the resistors 110 used are high it is preferable to use under the layer 107 a layer like 87 which is preferably corresponding to the layer 98, i.e. holes 85 has been cut into it so that the resistors do not cause any bosses. All the necessary conductors 91 are arranged in one place further to a band 117, at the end 118 of which connectors 119 can be crimped for coupling to a preamplifier.

When necessary the whole electronics can be arranged into the same structure. By arranging enough space all the electronics needed by the signal processing unit can be accommodated on the lower surface 92. Thus a multiple layer circuit plate has to be used to replace the layer 107, and the noise protection needed by the Emfit® film has to be arranged in the middle layer of the circuit board. Thus the structure becomes easily thicker but however still much thinner than the traditional preamplifiers. Especially if it is acceptable to make the hole for the preamplifier in the side of the guitar, a very durable and economical new type of preamplifier can be manufactured.

The surface film 101 can if necessary be replaced by thin and flexible display such as so called OLED (organic light emitting display) display or soon available thin and flexible LCD display. With display like these all the symbols and visual information can be variable and a multiple stage/level interface can be achieved. The advantages of it are for example that in the basic state only the most necessary controllers can be seen, and when it is necessary to adjust a single operation, one chooses the operation from the interface and the display is changed accordingly, like is at mobile phones for example. The display can also be a hard glass traditional LCD display if the device is installed on a straight surface. They can also be so thin that when pressed a pressure is generated so precisely that so called crosstalk does not exist. Further, when Emfit® electret bubble film is used that is very press sensitive but not sensitive for bending the crosstalk problem is otherwise also little.

Suitable glue is used between different film layers which in a preferable manufacturing method is water-based and very fluent whereby it can be spread on the film surfaces in roll-to-roll laminating with so called raster roller and in sheet lamination for example with a brush. In this purpose also an adhesive sheet film can be used, manufactured among others by 3M. Lamination can be performed as a whole or as a part of sheet lamination, and partly roll-to-roll. More specifically the lamination, alignment and cutting have been described in the above mentioned patent documents.

As told above the areas 106 of the rows have been coupled with resistors or capacitors to each other and only the outermost areas with connectors 119 to the circuit board wherefrom they are further coupled to a suitable preamplifier and further to a microcontroller. Due to the resistors or capacitors 110 between the electrode areas when a single area is pressed the charge amplitude is identified with different values by preamplifiers depending on the place in the row 108 the area 106 is located. So the pressed place can be calculated separately with a microcontroller, for example Microchip PIC16F88-I/SO, and the digital signal processing circuits can be controlled accordingly and a desired operation can be adjusted. With this kind of coupling the number of amplifiers needed and the costs for electronics can be maintained low. It has to be noted that this is only an example how the electronics can be arranged and its switching diagram can vary very much due to the desired operations and variety of the control possibilities, according to the enclosed claims.

Due to the fact that when the transducer film is an electrically charged Emfit® electret bubble film, the voltage corresponding to the pressing is directly proportional to the pressing force. In this case also the voltage amplitude can be used in the control of the operations of the device. For example strong pressing in a certain place changes the operation to another than light pressing.

Because in the element according to the invention an electrically charged electret bubble film is used as a transducer film, every pressing has en effect that a voltage is generated between the signal electrode and the ground plane. This voltage can be for example rectified with a rectifier and connected to an accumulator of the device, whereby the operation time of the accumulator with the same charging becomes longer. Further correspondingly manufactured transducer elements can be arranged into the device, for example on its outer surface, which are only used to generate a voltage when the device is touched and which is further rectified to the accumulators of the device. Preferably these elements have several transducer films, for example 5 or even 10 transducer films can on each other with opposite sides against each other.

If the device wherein a display and/or touch pad based on electret bubble film is located, is often exposed to high temperature, its sensitivity may become weaker. If so, it is followed by a worsening of the touch feeling of the keypad (harder pressing is needed). The device may have a processor which repairs the case automatically with a suitable algorithm. For example a temperature measuring sensor is placed in the device whereby based on the information from the sensor (temperature and time), for example when a certain threshold is exceeded, for example 50° C., the algorithm automatically begins to correct the gain of the preamplifier. The higher the temperature is and the longer time, the bigger is the correction of the gain. For example a variable describing the temperature exposure (is stored into a EEPROM or corresponding non-volatile memory), is increased the faster the more the temperature is below a certain threshold value. This value can be the basis for determination of the sensitivity according to which the basic setting of the temperature is adjusted. With other words a certain register is increased when the temperature is higher than a certain value according to how much this value has been exceeded. This is performed with certain intervals for example four times per hour. The current consumption can be remained in a lower value when the following is done: the device wakes let us say every 15 minutes in order to sample the temperature to perform integration. The occasion takes some milliseconds. Many processors have timers which remain running when the processor is put into a sleeping minimum current state. When the timer is reset it wakes up the whole processor—and further often so that it directly goes to run an interruption routine where the temperature damage integrator would be placed. The thermal time constant of the temperature sensor of the device has to be high enough—that means that it is fixed into a body that has enough heat charging capacity. The keypad may have an automatically calibrating amplification. The device may observe what kind of signals coming from the keyboard and it will change the amplification according to it with small changes. The device may also have a combination of these two and possibly use also reference sensor made of for example piezoelectric crystal with high ambient temperature tolerance.

It is apparent for a skilled person that the different embodiments are not limited to the examples presented above but they can be varied according to the enclosed claims. The invention can be applied to be used also in other keypads.

1. An electromechanical control unit (12) for a musical instrument having keypad and/or touch pad areas (102) for controlling a signal processing unit,
wherein the control unit (12) includes a surface element (101),
whereby settings and values of said signal processing unit that can be changed by the user are controlled by touching of the surface element,
which surface element has keypad and/or touch areas (102) provided with fixed and/or alternating symbols whereby changeable parameter values of the signal processing unit are controlled by touching and/or by gliding on said symbol with finger(s) or some other means,
characterised in that in order to adjust the parameter values that can be changed by the user the control unit consists of a thin and elastic layered structure whereby touching it generates there between the electrode surfaces a charge or voltage or capacitance change the place and/or amplitude of which is calculated with a microprocessor or alike, and based on this information said changeable parameter values are changed.

2. A control unit as claimed in claim 1 characterised in that it includes at least one sensor matrix element (108) wherein at least part of the signal electrodes (106) corresponding to the touch sensitive areas (102) is coupled with resistors or capacitors (110) to each other and whereby the areas coupled to each other have at their outermost areas (109) been coupled to preamplifiers.

3. A sensor matrix element as claimed in claim 2 characterised in that when a single place is pressed the place that has been pressed can be calculated from signals having different values at the preamplifiers due to the resistors or capacitors, whereby the signal processing unit is controlled with this information.

4. A device as claimed in claim 1 characterised in that based on the pressing force the operation of the pressed area can be affected.

5. A device as claimed in claim 1 characterised in that in connection with the pressing the electric charge generated between the electrodes (106, 105) located on the outer surfaces of the transducer film is used to charge the batteries of the device.

6. A device as claimed in claim 1 characterised in that the electromechanical film (95) is an so called electret bubble film.

7. A device as claimed in claim 1 characterised in that an electronic switching circuit is applied in the signal processing unit in order to adjust the gain of the preamplifiers of the keypad or touch pad and to set the touch sensation suitable for the user.

8. An electronic coupling circuit as claimed in claim 7 characterised in that it comprises a processor for automatic adjustment of the gain of the preamplifiers with help of a mathematic algorithm.

9. An electronic coupling circuit as claimed in claim 8 characterised in that it comprises temperature measurement means.

10. A device as claimed in claim 1 characterised in that it is of thin and elastic material.

11. A device as claimed in claim 1 characterised in that a display is arranged on its outer surface.

12. A device as claimed in claim 11 characterised in that the display is of thin and elastic material.

13. A device as claimed in claim 1 characterised in that the electromechanical response is based on piezoelectric material arranged in for of film or paint.
